(19) United States
(12) Patent Application Publication
(10) Pub. No.: US 2026/0349780 A1
(43) Pub. Date: Nov. 5, 2026

(54) INFORMATION TRANSFER APPARATUS AND METHOD OF TRANSFERRING INFORMATION

(71) Applicant: MITSUBISHI ELECTRIC CORPORATION, Tokyo (JP)

(72) Inventors: Masashi TSUCHIDA, Tokyo (JP); Daisuke KAWAKAMI, Tokyo (JP)

(73) Assignee: MITSUBISHI ELECTRIC CORPORATION, Tokyo (JP)

(21) Appl. No.: 19/483,618

(22) PCT Filed: Jun. 30, 2023
(86) PCT No.: PCT/JP2023/024497

§ 371 Date: Nov. 12, 2025

(51) Int. Cl. G06F 9/48; G06F 3/0484

(52) U.S. Cl. CPC G06F 9/4806; G06F 3/0484

(57) ABSTRACT

An object is to provide a technology that can ensure real-time performance on control over a control device. An information transfer apparatus includes at least one of a real-time data processing unit or a non-real-time data processing unit. The real-time data processing unit includes a first data management unit that manages data from a control data generating unit, a first data collection unit, and non-real-time data processing unit. The non-real-time data processing unit includes a second data management unit that manages data from a second data collection unit and the real-time data processing unit.

### BACKGROUND OF THE INVENTION

### Field of the Invention

The present disclosure relates to an information transfer apparatus and a method of transferring information.

### Description of the Background Art

Various technologies on control devices to be used in production sites have been proposed (e.g., Patent Document 1).

### PRIOR ART DOCUMENT

### Patent Document

Patent Document 1: Japanese Patent Application Laid-Open No. 2022-101969

### SUMMARY

### Problem to be Solved by the Invention

For control devices each of which is used in a production site and executes a plurality of Operating Systems (OSs), it is desirable to output data on, for example, a motion control device and a sequencer control device to an exterior while storing the data in storage to make use the data. When a plurality of OSs have undergone the storage and the output in the same manner, there has been a problem in that real-time performance on control over an external control device cannot be ensured.

Thus, the present disclosure has been conceived in view of the problem, and has an object of providing a technology that can ensure real-time performance on control over a control device.

### Means to Solve the Problem

An information transfer apparatus according to the present disclosure includes: a real-time data processing unit to perform a process on a real-time operating system; a real-time data storage handled by the real-time data processing unit; a non-real-time data processing unit to perform a process on a non-real-time operating system; and a non-real-time data storage handled by the non-real-time data processing unit, the real-time data processing unit including: a device controller to control a control device connected to an exterior; a control data generating unit to generate a command value for controlling the control device, and transmit the command value to the device controller: a first data collection unit to receive a feedback value from the control device; a first inter-operating-system communication unit to communicate with the non-real-time data processing unit; and a first data management unit to manage, between the control data generating unit, the first data collection unit, the first inter-operating-system communication unit, and the real-time data storage, the command value, the feedback value, and data received by the first inter-operating-system communication unit from the non-real-time data processing unit, and the non-real-time data processing unit including: a second data collection unit to receive input information from an input device connected to an exterior; a second inter-operating-system communication unit to communicate with the real-time data processing unit; and a second data management unit to manage, between the second data collection unit, the second inter-operating-system communication unit, and the non-real-time data storage, the input information and data received by the second inter-operating-system communication unit from the real-time data processing unit.

### Effects of the Invention

Since the real-time data processing unit and the non-real-time data processing unit can mutually transfer data according to the present disclosure, the real-time performance of the real-time data processing unit on control over a control device can be ensured.

The object, features, aspects, and advantages of this disclosure will become more apparent from the following detailed description and the accompanying drawings.

### BRIEF DESCRIPTION OF THE DRAWINGS

FIG. 1 is a block diagram illustrating a system configuration of an information transfer apparatus according to Embodiment 1.

FIG. 2 is a block diagram illustrating a functional configuration of the information transfer apparatus according to Embodiment 1.

FIG. 3 is a diagram illustrating a sequence of the information transfer apparatus according to Embodiment 1.

FIG. 4 is a diagram illustrating a sequence of the information transfer apparatus according to Embodiment 1.

FIG. 5 is a diagram illustrating a sequence of the information transfer apparatus according to Embodiment 1.

FIG. 6 is a diagram illustrating a sequence of the information transfer apparatus according to Embodiment 1.

FIG. 7 is a flowchart illustrating operations of the information transfer apparatus according to Embodiment 2.

FIG. 8 is a diagram illustrating a sequence of the information transfer apparatus according to Embodiment 2.

FIG. 9 is a diagram illustrating a sequence of the information transfer apparatus according to Embodiment 2.

FIG. 10 is a block diagram illustrating a functional configuration of the information transfer apparatus according to Embodiment 3.

FIG. 11 illustrates selection conditions according to Embodiment 3.

FIG. 12 is a diagram illustrating operations of the information transfer apparatus according to Embodiment 3.

FIG. 13 is a diagram illustrating a sequence of the information transfer apparatus according to Embodiment 4.

### DESCRIPTION OF THE PREFERRED EMBODIMENTS

### Embodiment 1

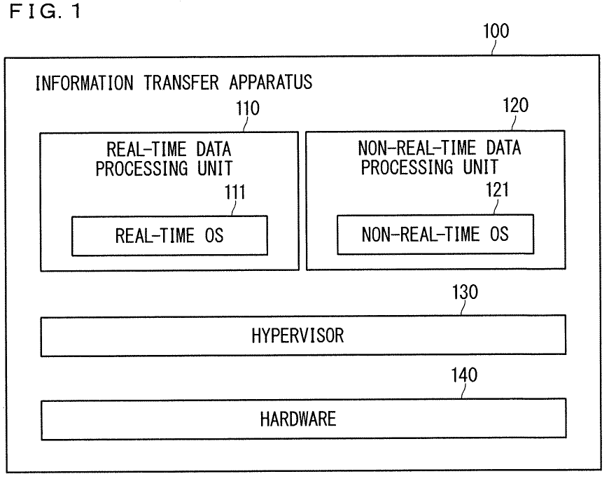

FIG. 1 is a block diagram illustrating a system configuration of an information transfer apparatus 100 according to Embodiment 1. Data and information are substantially the same in the following description.

The information transfer apparatus 100 is, for example, an industrial computer that collects data from FA equipment to be used in a production site and that performs processes such as feedback. The information transfer apparatus 100 includes hardware 140 and a hypervisor 130.

The hypervisor 130 operates on the hardware 140. A real-time OS 111 and a non-real-time OS 121 that are guest OSs operate on the hypervisor 130. For example, a plurality of files such as an application program and user data exist on each of the real-time OS 111 and the non-real-time OS 121.

A real-time data processing unit 110 performs real-time data processing on the real-time OS 111, and a non-real-time data processing unit 120 performs non-real-time data processing on the non-real-time OS 121. The real-time data processing should be superior in real-time performance on data processing to the non-real-time data processing.

The hypervisor 130 is a software program for implementing operating environments of a plurality of OSs including the real-time OS 111 and the non-real-time OS 121. The hypervisor 130 allocates the processing capacity of a central processing unit (CPU) and resources of the hardware 140 such as recording regions of a random access memory (RAM), a read-only memory (ROM), and hard disk to the real-time data processing unit 110 and the non-real-time data processing unit 120 that are virtual machines.

The recording region to be handled by the real-time data processing unit 110 is used as a real-time data storage, and the recording region to be handled by the non-real-time data processing unit 120 is used as a non-real-time data storage. The real-time data processing unit 110 and the non-real-time data processing unit 120 are virtualized computers that operate on the hypervisor 130. Thus, each of the real-time data processing unit 110 and the non-real-time data processing unit 120 can behave like hardware of a single computer.

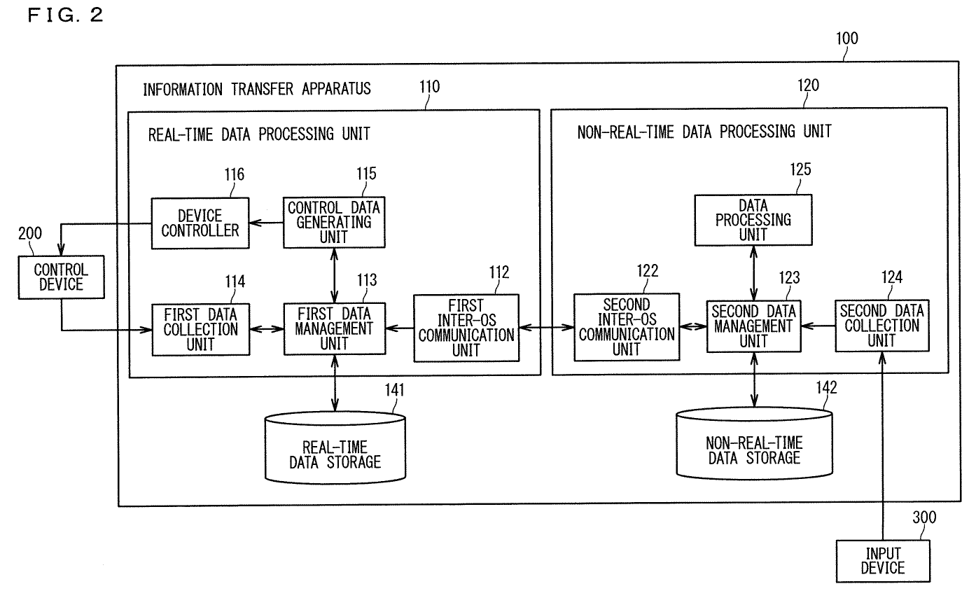

FIG. 2 is a block diagram illustrating a functional configuration of the information transfer apparatus 100 according to Embodiment 1. As described above, the information transfer apparatus 100 includes the real-time data processing unit 110, the non-real-time data processing unit 120, a real-time data storage 141, and a non-real-time data storage 142.

### Real-Time Data Processing Unit

The real-time data processing unit 110 includes a device controller 116, a control data generating unit 115, a first data collection unit 114, a first data management unit 113, and a first inter-OS communication unit 112.

The device controller 116 includes an interface for communicating with a control device 200 connected to an exterior of the information transfer apparatus 100. The device controller 116 controls the control device 200 by converting a command value transmitted from the control data generating unit 115 into a control command value that can be input to the control device 200 and outputting the control command value to the control device 200. Examples of the control device 200 include control devices such as a motion control device and a sequencer control device provided in a robot arm and a belt conveyor.

The control data generating unit 115 receives a feedback value from the control device 200 through the first data collection unit 114, or receives processed data from the non-real-time data processing unit 120 through the first inter-OS communication unit 112. The control data generating unit 115 generates a command value for controlling the control device 200, based on at least one of the feedback value or the processed data, and transmits the command value to the device controller 116. In this Description, for example, at least one of A, B, C, . . . , or Z means any one of all combinations obtained by combining one type or more extracted from each of groups of A, B, C, . . . , and Z.

Furthermore, the control data generating unit 115 transmits the command value to the first data management unit 113 as necessary. The real-time data processing unit 110 needs to generate a command value for generating a control command value, because the control command value needs to be transmitted to the control device 200 connected to an exterior in a specific cycle that can ensure real-time performance.

The first data collection unit 114 includes an interface for communicating with the control device 200. The first data collection unit 114 receives a feedback value from the control device 200 and transmits the feedback value to the first data management unit 113.

The first inter-OS communication unit 112 includes an inter-OS interface for communicating with the non-real-time data processing unit 120, and exchanges data with the non-real-time data processing unit 120. For example, through this communication, the first inter-OS communication unit 112 transmits various requests to the non-real-time data processing unit 120 or receives data from the non-real-time data processing unit 120.

The first data management unit 113 includes an interface for communicating with the real-time data storage 141. The first data management unit 113 performs management to exchange, between the control data generating unit 115, the first data collection unit 114, the first inter-OS communication unit 112, and the real-time data storage 141, the command value, the feedback value, and data received by the first inter-OS communication unit 112 from the non-real-time data processing unit 120. Example management by the first data management unit 113 will be described later.

### Non-Real-Time Data Processing Unit

The non-real-time data processing unit 120 includes a data processing unit 125, a second data collection unit 124, a second data management unit 123, and a second inter-OS communication unit 122.

The second data collection unit 124 includes an interface for communicating with an input device 300 connected to an exterior of the information transfer apparatus 100. The second data collection unit 124 receives input information from the input device 300 and transmits the input information to the second data management unit 123.

The data processing unit 125 receives the input information from the second data collection unit 124 through the second data management unit 123, generates processed data by performing processing such as computation based on the input information, and transmits the processed data to the second data management unit 123. For example, when the input information is image data of a camera, the data processing unit 125 generates the processed data including at least one of a result of detection of an object from an image, a result of detection of, for example, a foreign object in the image, or a result of prediction of deterioration of an object. Although FIG. 2 illustrates separate installation of the control device 200 and the input device 300, the control device 200 and the input device 300 may be a single device.

The second inter-OS communication unit 122 includes an inter-OS interface for communicating with the real-time data processing unit 110, and exchanges data with the real-time data processing unit 110. For example, through this communication, the second inter-OS communication unit 122 transmits processed data to the real-time data processing unit 110 or receives data from the real-time data processing unit 110.

The second data management unit 123 includes an interface for communicating with the non-real-time data storage 142. The second data management unit 123 performs management to exchange, between the data processing unit 125, the second data collection unit 124, the second inter-OS communication unit 122, and the non-real-time data storage 142, the processed data, the input information, and data received by the second inter-OS communication unit 122 from the real-time data processing unit 110. Example management by the second data management unit 123 will be described later.

### Sequence

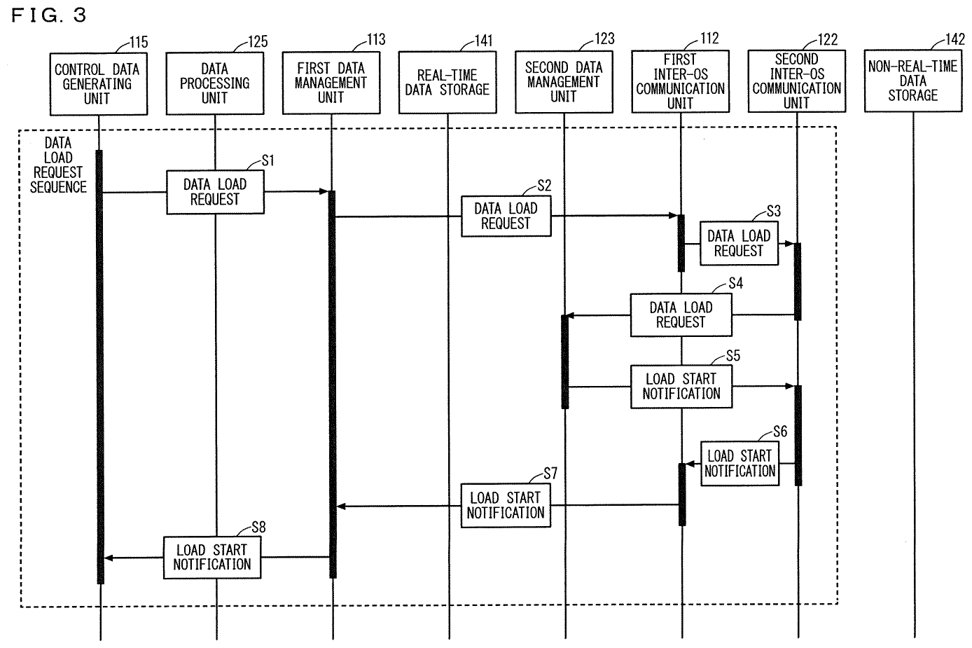

FIG. 3 illustrates a sequence when the information transfer apparatus 100 according to Embodiment 1 starts transferring information.

In Step S1, the control data generating unit 115 of the real-time data processing unit 110 transmits a request for starting to transfer information between the real-time data processing unit 110 and the non-real-time data processing unit 120, to the first data management unit 113 as a data load request. The data load request may include a type of information to be transferred.

In Steps S2 to S4, the first data management unit 113 transmits the data load request to the second data management unit 123 through the first inter-OS communication unit 112 and the second inter-OS communication unit 122. The description of the first inter-OS communication unit 112 and the second inter-OS communication unit 122 may be omitted when data is transmitted between the first data management unit 113 and the second data management unit 123 for convenience of description.

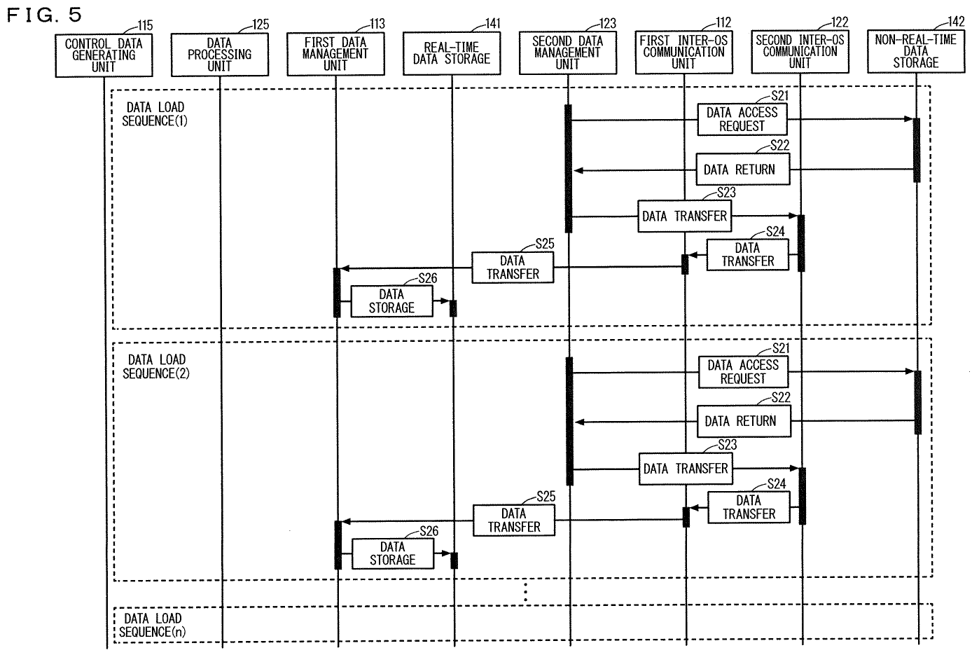

Upon receipt of the data load request, that is, a request for starting to transfer information, the second data management unit 123 determines whether information can be transferred. When determining that the information can be transferred, the second data management unit 123 transmits a load start notification to the first data management unit 113 through the second inter-OS communication unit 122 and the first inter-OS communication unit 112 in Steps S5 to S7. In Step S8, the first data management unit 113 transmits the load start notification to the control data generating unit 115. Subsequently, the second data management unit 123, for example, accesses data on a regular basis and transmits the data to the first data management unit 113 as illustrated in FIG. 5 which will be described later.

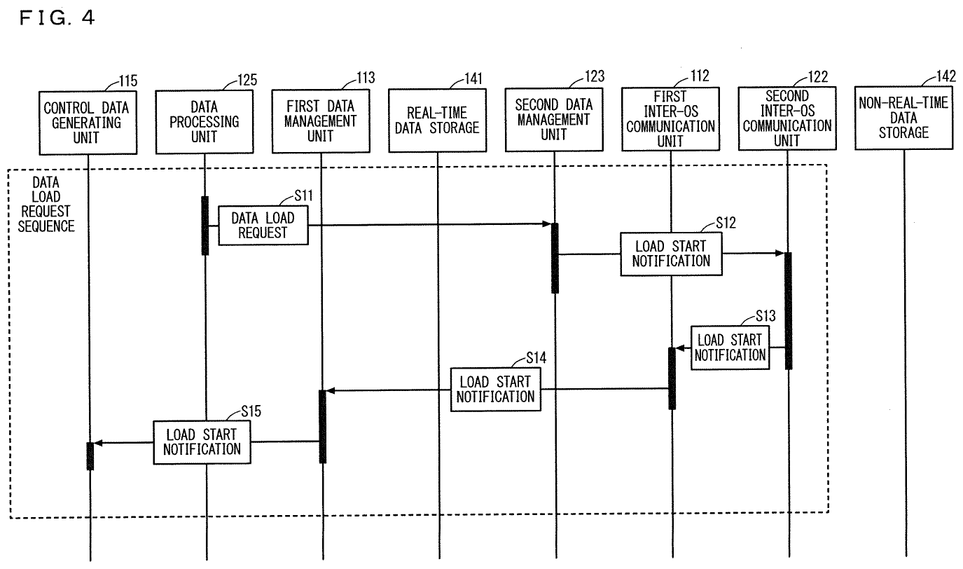

FIG. 4 illustrates another sequence when the information transfer apparatus 100 according to Embodiment 1 starts transferring information. While a source of a data load request in FIG. 3 is the control data generating unit 115 in FIG. 3, a source of a data load request in FIG. 4 is the data processing unit 125.

In Step S11, the data processing unit 125 of the non-real-time data processing unit 120 transmits a data load request to the second data management unit 123. When the second data management unit 123 receives the data load request, the same processes as Steps S5 to S8 in FIG. 3 are performed in Steps S12 to S15, respectively. As illustrated in FIGS. 3 and 4, a stimulus for starting transferring information may be given from the real-time data processing unit 110 or the non-real-time data processing unit 120.

FIG. 5 illustrates a sequence, that is, a data load sequence for the non-real-time data processing unit 120 to transfer processed data to the real-time data processing unit 110 in the information transfer apparatus 100 according to Embodiment 1. Before the sequence in FIG. 5 is performed, the processed data is already stored in the non-real-time data storage 142.

In Step S21, the second data management unit 123 transmits a data access request to the non-real-time data storage 142. After transmission of the processed data from the non-real-time data storage 142 in Step S22, the second data management unit 123 transmits the processed data to the first data management unit 113 through the second inter-OS communication unit 122 and the first inter-OS communication unit 112 in Steps S23 to S25. In Step S26, the first data management unit 113 stores the received processed data in the real-time data storage 141.

Regular execution of a series of processes in Steps S21 to S26 allows the processed data required by the real-time data processing unit 110 to be regularly transmitted to the real-time data processing unit 110 and regularly stored in the real-time data storage 141. While the example in FIG. 5 illustrates a regular transfer of the processed data from the non-real-time data processing unit 120 to the real-time data processing unit 110, a transfer may be made each time processed data is generated.

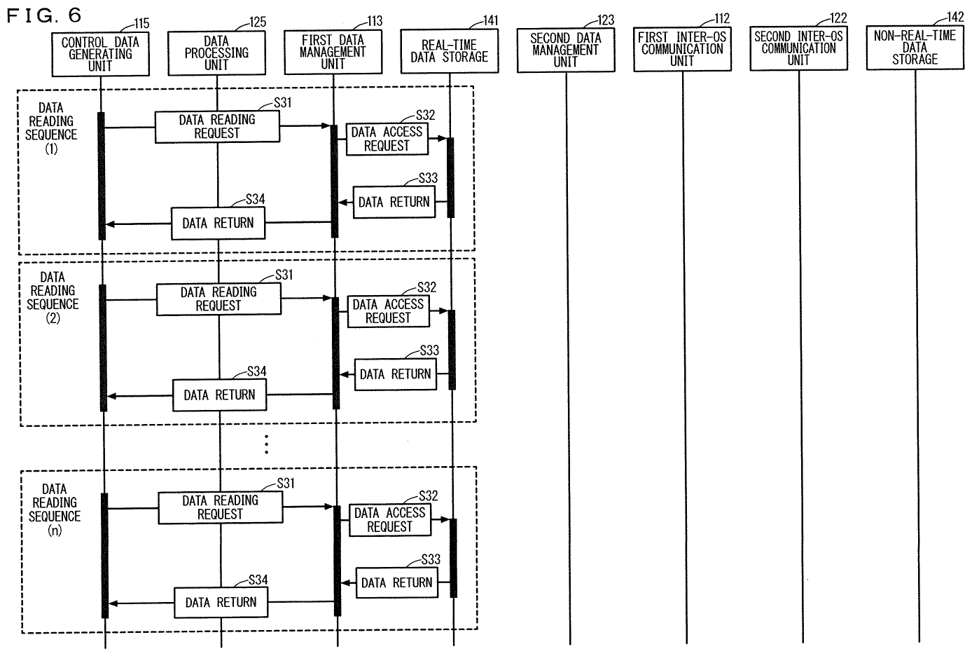

FIG. 6 illustrates a sequence, that is, a data reading sequence for the control data generating unit 115 to obtain the processed data from the real-time data storage 141 in the information transfer apparatus 100 according to Embodiment 1.

In Step S31, the control data generating unit 115 transmits a data reading request to the first data management unit 113. In Step S32, the first data management unit 113 transmits a data access request to the real-time data storage 141. When the real-time data storage 141 transmits the processed data to the first data management unit 113 in Step S33, the first data management unit 113 returns the processed data to the control data generating unit 115 in Step S34. Regular transmission of a data reading request from the control data generating unit 115 allows the control data generating unit 115 to regularly obtain necessary processed data. The control data generating unit 115 may transmit a data reading request not regularly but as necessary.

In FIGS. 5 and 6, the processed data stored in the non-real-time data storage 142 is once stored in the real-time data storage 141, and then obtained by the control data generating unit 115, which is not limited to this. For example, the processed data generated by the data processing unit 125 may be stored in the real-time data storage 141, and then obtained by the control data generating unit 115.

### Summary of Embodiment 1

The aforementioned information transfer apparatus 100 according to Embodiment 1 includes the real-time data processing unit 110 and the non-real-time data processing unit 120 which can mutually transfer data. Under such a structure, the real-time data processing unit 110 can obtain data for a non-real-time data process that does not require real-time performance from the non-real-time data processing unit 120, while performing a real-time data process requiring the real-time performance. Thus, the real-time performance of the real-time data processing unit on control over the control device 200 can be ensured.

Furthermore, in Embodiment 1, the second data management unit 123 stores the processed data in the real-time data storage 141 through the first data management unit 113, and the control data generating unit 115 obtains the processed data from the real-time data storage 141 through the first data management unit 113. Under such a structure, the control data generating unit 115 can obtain the processed data from within the real-time data processing unit 110, without accessing the non-real-time data storage 142 or transferring the processed data between OSs. Since this can improve the real-time performance of the control data generating unit 115 on obtainment of the processed data, the real-time performance of the real-time data processing unit 110 can be improved.

### Embodiment 2

A system configuration of the information transfer apparatus 100 according to Embodiment 2 is identical to that of the information transfer apparatus 100 according to Embodiment 1 in FIG. 1, and a functional configuration of the information transfer apparatus 100 according to Embodiment 2 is identical to that of the information transfer apparatus 100 according to Embodiment 1 in FIG. 2. Hereinafter, constituent elements according to Embodiment 2 identical or similar to those described above will be denoted by the same or similar reference numerals, and different constituent elements will be mainly described.

The real-time data storage 141 and the non-real-time data storage 142 can store processed data, similarly to Embodiment 1. When processed data is not stored in the real-time data storage 141, the first data management unit 113 requested of the processed data from the control data generating unit 115 is configured to obtain the processed data from the non-real-time data storage 142 through the second data management unit 123.

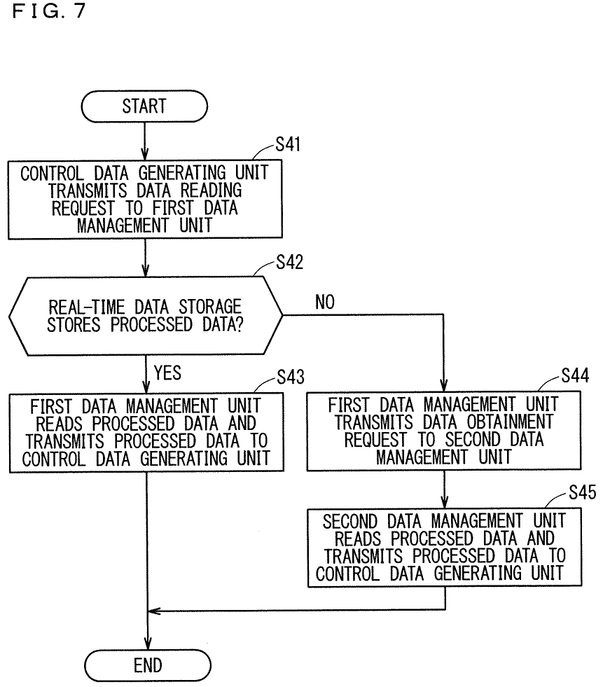

FIG. 7 is a flowchart illustrating operations of the information transfer apparatus 100 according to Embodiment 2.

In Step S41, the control data generating unit 115 transmits, to the first data management unit 113, a data reading request on processed data to be used in generating a command value, similarly to Step S31 in FIG. 6. In Step S42, the first data management unit 113 confirms whether the real-time data storage 141 stores the processed data to be used. When storage of the processed data has been confirmed, the processes proceed to Step S43. When storage of the processed data is not confirmed, the processes proceed to Step S44.

Upon proceeding to Step S43, a sequence of processes when the processed data is stored in the real-time data storage is executed. Specifically, the first data management unit 113 reads the processed data from the real-time data storage 141, and transmits the processed data to the control data generating unit 115. Then, the operations in FIG. 7 end.

Upon proceeding to Step S44, a sequence of processes when the processed data is not stored in the real-time data storage is executed. Specifically, the first data management unit 113 transmits, to the second data management unit 123, a data obtainment request for obtaining the processed data requested by the control data generating unit 115. In Step S45, the second data management unit 123 reads the processed data from the non-real-time data storage 142, and transmits the processed data to the control data generating unit 115 through the first data management unit 113.

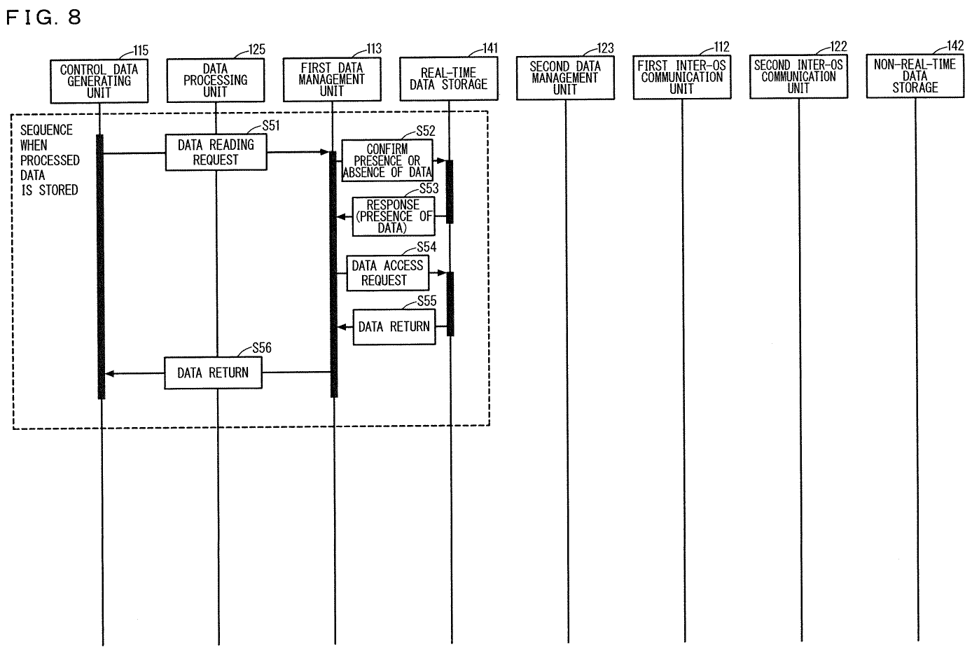

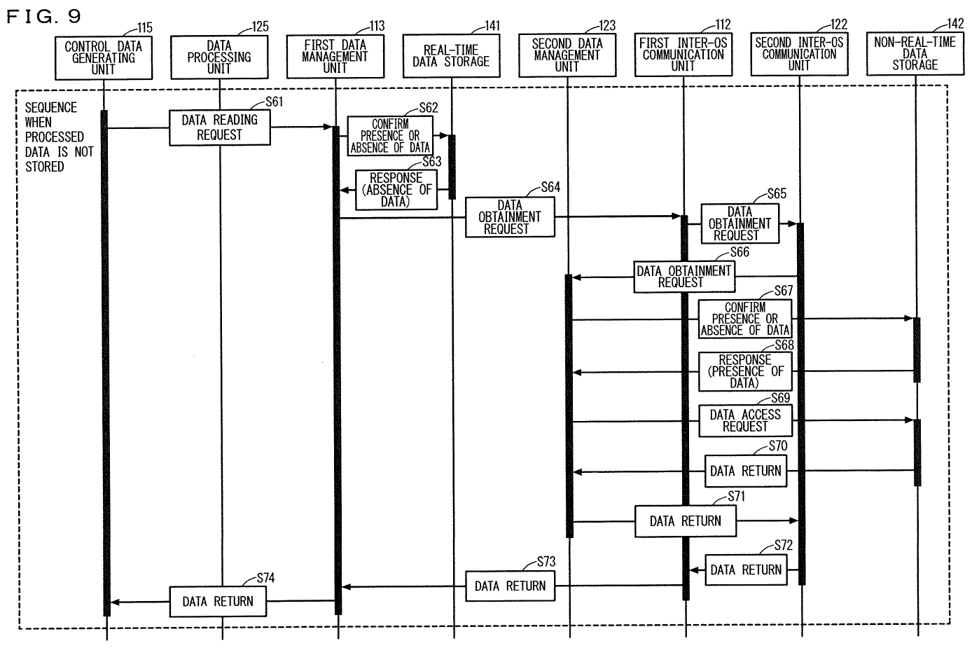

FIGS. 8 and 9 illustrate sequences for the control data generating unit 115 to obtain the processed data from the non-real-time data storage 142 in the information transfer apparatus 100 according to Embodiment 2. The sequence in FIG. 8 corresponds to the processes in Steps S41, S42, and S43 of FIG. 7.

In Step S51, the control data generating unit 115 transmits a data reading request to the first data management unit 113. In Step S52, the first data management unit 113 that has received the data reading request causes the real-time data storage 141 to confirm whether the requested processed data is stored in the real-time data storage 141. In Step S53, the first data management unit 113 receives, from the real-time data storage 141, a response indicating that the processed data is stored.

In Step S54, the first data management unit 113 transmits a data access request to the real-time data storage 141. When the real-time data storage 141 transmits the processed data to the first data management unit 113 in Step S55, the first data management unit 113 transmits the processed data to the control data generating unit 115 in Step S56.

The sequence in FIG. 9 corresponds to the processes in Steps S41, S42, S44, and S45 of FIG. 7.

In Step S61, the control data generating unit 115 transmits a data reading request to the first data management unit 113. In Step S62, the first data management unit 113 that has received the data reading request causes the real-time data storage 141 to confirm whether the requested processed data is stored in the real-time data storage 141. In Step S63, the first data management unit 113 receives, from the real-time data storage 141, a response indicating that the processed data is not stored.

In Steps S64 to S66, the first data management unit 113 transmits a data obtainment request on the requested processed data, to the second data management unit 123 through the first inter-OS communication unit 112 and the second inter-OS communication unit 122. In Step S67, the second data management unit 123 causes the non-real-time data storage 142 to confirm whether the requested processed data is stored in the non-real-time data storage 142. In Step S68, the second data management unit 123 receives, from the non-real-time data storage 142, a response indicating that the processed data is stored.

In Step S69, the second data management unit 123 transmits a data access request to the non-real-time data storage 142. After transmission of the processed data from the non-real-time data storage 142 in Step S70, the second data management unit 123 transmits . the processed data to the first data management unit 113 through the second inter-OS communication unit 122 and the first inter-OS communication unit 112 in Steps S71 to S73. In Step S74, the first data management unit 113 transmits the received processed data to the control data generating unit 115.

### Summary of Embodiment 2

When processed data is not stored in the real-time data storage 141, the first data management unit 113 requested of the processed data from the control data generating unit 115 obtains the processed data from the non-real-time data storage 142 through the second data management unit 123 in the information transfer apparatus 100 according to Embodiment 2. Under such a structure, minimal access to the non-real-time data storage 142 and minimal transfer of processed data between OSs allow the control data generating unit 115 to obtain the processed data. Thus, the control data generating unit 115 can obtain the processed data from the real-time data storage 142 in the absence of the corresponding processed data in the real-time data storage 141.

### Embodiment 3

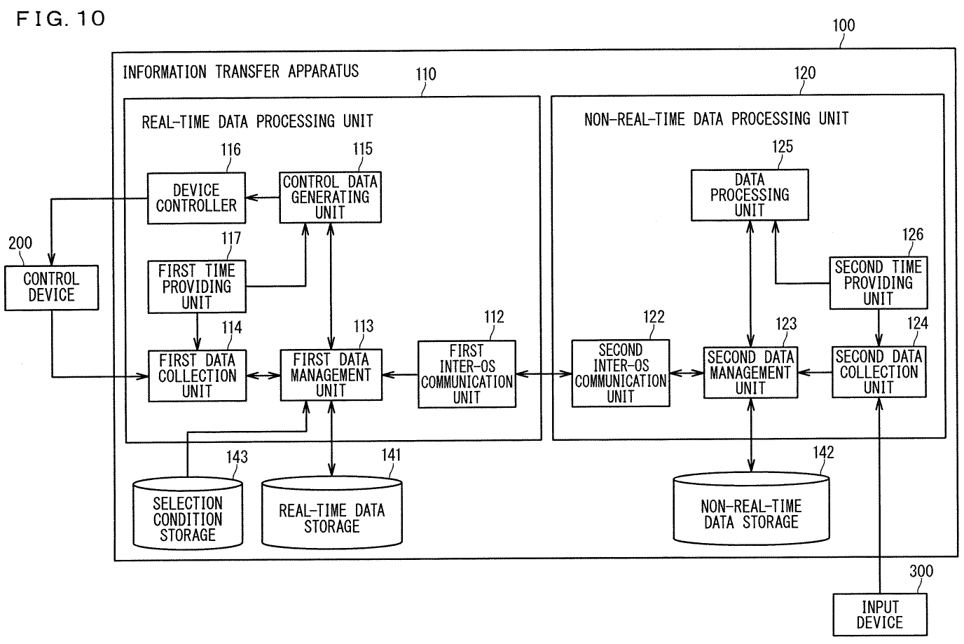

A system configuration of the information transfer apparatus 100 according to Embodiment 3 is identical to that of the information transfer apparatus 100 according to Embodiment 1 in FIG. 1. FIG. 10 is a block diagram illustrating a functional configuration of the information transfer apparatus 100 according to Embodiment 3. Hereinafter, constituent elements according to Embodiment 3 identical or similar to those described above will be denoted by the same or similar reference numerals, and different constituent elements will be mainly described.

The configuration of FIG. 10 is a configuration obtained by adding, to the configuration of FIG. 2, a selection condition storage 143, a first time providing unit 117 of the real-time data processing unit 110, and a second time providing unit 126 of the non-real-time data processing unit 120.

The first time providing unit 117 and the second time providing unit 126 are included in the concept of a time providing unit. The first time providing unit 117 and the second time providing unit 126 each provide time information to be added as a time stamp to selection target data stored in the real-time data storage 141. The selection target data in Embodiment 3 is a command value generated by the control data generating unit 115, a feedback value obtained by the first data collection unit 114, processed data generated by the data processing unit 125, and input information obtained by the second data collection unit 124. The selection target data may be at least one of these or information except these.

The first time providing unit 117 transmits the time information to the control data generating unit 115 and the first data collection unit 114. The control data generating unit 115 adds the time information to a command value, and stores the command value in the real-time data storage 141 through the first data management unit 113. The first data collection unit 114 adds the time information to a feedback value, and stores the feedback value in the real-time data storage 141 through the first data management unit 113.

The second time providing unit 126 transmits time information to the data processing unit 125 and the second data collection unit 124. The data processing unit 125 adds the time information to the processed data, and stores the processed data in the real-time data storage 141 through the second data management unit 123 and the first data management unit 113. The second data collection unit 124 adds the time information to input information, and stores the input information in the real-time data storage 141 through the second data management unit 123 and the first data management unit 113.

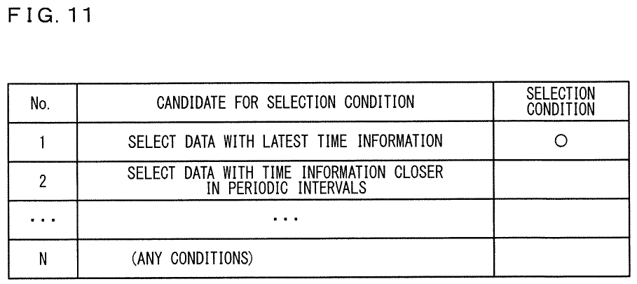

The selection condition storage 143 stores a selection condition. FIG. 11 indicates candidates for selection conditions that are available as selection conditions, and selection conditions currently used. The selection conditions are conditions on time information for selecting and obtaining, from the real-time data storage 141, selection target data to which the time information has been added. The selection conditions, and the number of candidates for selection conditions that are available as selection conditions are not limited to the conditions and the number in FIG. 11.

The first data management unit 113 includes an interface for communicating with the selection condition storage 143. The first data management unit 113 selects and obtains the selection target data from the real-time data storage 141 based on the selection conditions, when the control data generating unit 115 requests the selection target data.

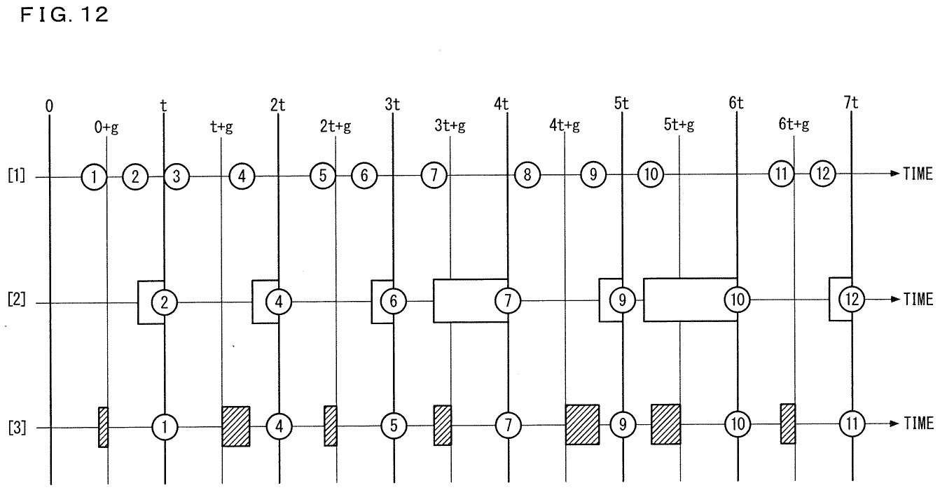

FIG. 12 is a diagram for describing selection of the selection target data by the first data management unit 113. While the following will describe, using FIG. 12, an example where the selection target data is processed data, the following will hold when the selection target data is a command value, a feedback value, or input information.

In FIG. 12, the time increases in the right direction along the horizontal axis, and a cycle in which the first data management unit 113, and eventually the control data generating unit 115 obtains data is t. [1] indicates the times of the time information added to the processed data, and the pecking order in which the time information is added.

[2] indicates the processed data to be selected using the no. 1 condition in the candidates for selection conditions in FIG. 11, and the time of the time information. Under this selection condition, processed data of the time that is the closest to the time (N+1)×in the processed data from the time N (N=0, 1, 2, . . . )×t to the time (N+1)×t is to be selected. The first data management unit 113 obtains the processed data to be selected at the time (N+1)×t. Open squares associated with the processed data in [2] each indicate a difference between the time of the time information added to the processed data to be selected and the time at which the first data management unit 113 obtains the processed data to be selected under the selection condition of [2], that is, jitters.

[3] indicates the processed data to be selected using the no. 2 condition in the candidates for selection conditions in FIG. 11, and the time of the time information. Under this selection condition, processed data of the time that is the closest to the time N×t+g that is shifted by any given time g from the time N×t in the processed data from the time N (N=0,1, 2, . . . )×t to the time (N+1)×t is to be selected. The first data management unit 113 obtains processed data to be selected at the time (N+1)×t. Hatched squares associated with the processed data in [3] each indicate a difference between the time of the time information added to the processed data to be selected and the time at which the first data management unit 113 obtains the processed data to be selected under the selection condition of [3], that is, jitters. While there is a probability that the jitters in [3] become jitters in a negative direction, an absolute value of the jitters in [3] can be half or less than that of the jitters in [2].

### Summary of Embodiment 3

In the aforementioned information transfer apparatus 100 according to Embodiment 3, when the control data generating unit 115 requests the selection target data, the first data management unit 113 selects and obtains the selection target data from the real-time data storage 141 based on the selection condition. Under such a structure, the control data generating unit 115 can use the selection target data selected under a desired selection condition.

### Embodiment 4

A system configuration of the information transfer apparatus 100 according to Embodiment 4 is identical to that of the information transfer apparatus 100 according to Embodiment 1 in FIG. 1, and a functional configuration of the information transfer apparatus 100 according to Embodiment 4 is identical to that of the information transfer apparatus 100 according to Embodiment 1 in FIG. 2. Hereinafter, constituent elements according to Embodiment 4 identical or similar to those described above will be denoted by the same or similar reference numerals, and different constituent elements will be mainly described.

In Embodiment 4, the first data management unit 113 stores, in the non-real-time data storage 142 through the second data management unit 123, at least one of the command value generated by the control data generating unit 115 or the feedback value received by the first data collection unit 114.

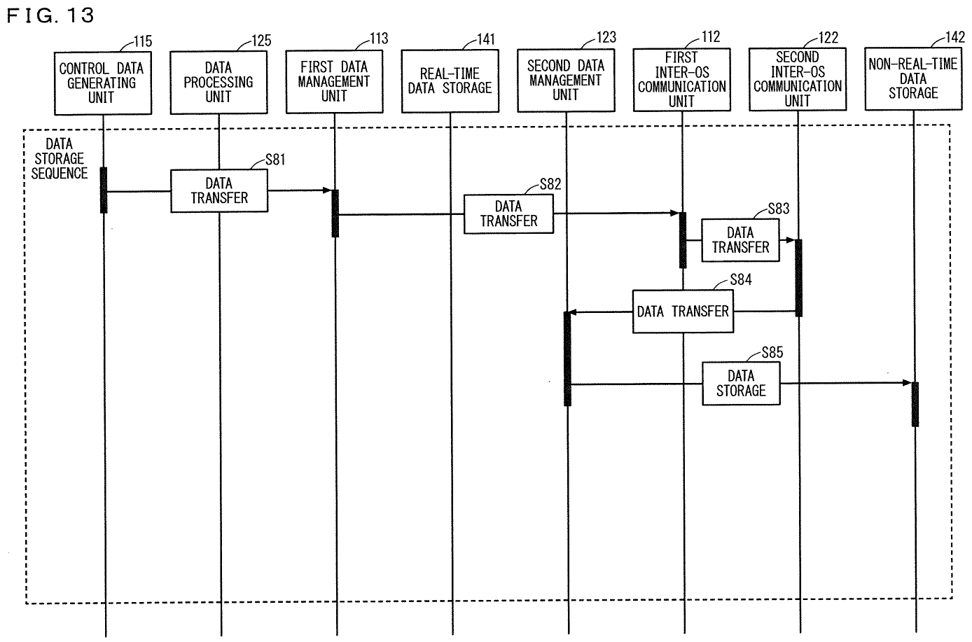

FIG. 13 illustrates a sequence for the control data generating unit 115 to store the command value in the non-real-time data storage 142 in the information transfer apparatus 100 according to Embodiment 4.

In Step S81, the control data generating unit 115 transmits a command value to the first data management unit 113. In Steps S82 to S84, the first data management unit 113 transmits the command value to the second data management unit 123 through the first inter-OS communication unit 112 and the second inter-OS communication unit 122. In Step S85, the second data management unit 123 stores the command value in the non-real-time data storage 142.

### Summary of Embodiment 4

In the aforementioned information transfer apparatus 100 according to Embodiment 4, the first data management unit 113 stores at least one of the command value or the feedback value in the non-real-time data storage 142 through the second data management unit 123. Since the non-real-time data processing unit 120 can take charge of a storage process of the real-time data processing unit 110 in such a structure, the real-time performance of the real-time data processing unit 110 can be improved.

### Modifications

The configurations of Embodiments 1 to 4 may be appropriately combined. A method of transferring information to be performed by the information transfer apparatus 100 may include the steps of: (i) transferring at least one of the command value or the feedback value to the real-time data processing unit 110 by the non-real-time data processing unit 120; and (ii) transferring the input information to the non-real-time data processing unit 120 by the real-time data processing unit 110. Furthermore, a process on the input information may be replaced with a process on the processed data, and these processes may be combined in the aforementioned description.

Embodiments and the modifications can be freely combined, and appropriately modified or omitted.

The foregoing description is in all aspects illustrative and not restrictive. Therefore, numerous modifications and variations that have not yet been exemplified are devised.

### EXPLANATION OF REFERENCE SIGNS

100 information transfer apparatus, 110 real-time data processing unit, 111 real-time OS, 112 first inter-OS communication unit, 113 first data management unit, 114 first data collection unit, 115 control data generating unit, 116 device controller, 117 first time providing unit, 120 non-real-time data processing unit, 121 non-real-time OS, 122 second inter-OS communication unit, 123 second data management unit, 124 second data collection unit, 125 data processing unit, 126 second time providing unit, 141 real-time data storage, 142 non-real-time data storage, 143 selection condition storage, 200 control device, 300 input device.

1. An information transfer apparatus, comprising
real-time data processing circuitry to perform a process on a real-time operating system,
the real-time data processing circuitry including:
a device controller to control a control device connected to an exterior;
control data generating circuitry to generate a command value for controlling the control device, and transmit the command value to the device controller;
first data collection circuitry to receive data from the control device; and
first data management circuitry to manage the command value from the control data generating circuitry, the data from the first data collection circuitry, and data from non-real-time data processing circuitry that performs a process on a non-real-time operating system, and
the non-real-time data processing circuitry including:
second data collection circuitry to receive input information from an input device connected to an exterior; and
second data management circuitry to manage the input information from the second data collection circuitry, and data from the real-time data processing circuitry.

2. The information transfer apparatus according to claim 1,
wherein the non-real-time data processing circuitry further includes data processing circuitry that generates processed data based on the input information, the second data management circuitry stores the processed data in a real-time data storage handled by the real-time data processing circuitry, through the first data management circuitry, and
the control data generating circuitry obtains the processed data from the real-time data storage through the first data management circuitry.

3. The information transfer apparatus according to claim 1, wherein the non-real-time data processing circuitry further includes data processing circuitry that generates processed data based on the input information, when a real-time data storage handled by the real-time data processing circuitry does not store the processed data, the first data management circuitry requested of the processed data from the control data generating circuitry obtains the processed data from a non-real-time data storage handled by the non-real-time data processing circuitry, through the second data management circuitry.

4. The information transfer apparatus according to claim 1, further comprising
time providing circuitry to provide time information to be added to selection target data to be stored in a real-time data storage handled by the real-time data processing circuitry,
wherein when the control data generating circuitry requests the selection target data, the first data management circuitry selects and obtains the selection target data based on a selection condition that is a condition on the time information for selecting and obtaining the selection target data to which the time information has been added.

5. The information transfer apparatus according to claim 1,
wherein the first data management circuitry stores, in a non-real-time data storage handled by the non-real-time data processing circuitry through the second data management circuitry, at least one of the command value generated by the control data generating circuitry or the data from the first data collection circuitry.

6. A method of transferring information to be performed by an information transfer apparatus,
the information transfer apparatus including
real-time data processing circuitry to perform a process on a real-time operating system,
the real-time data processing circuitry including:
a device controller to control a control device connected to an exterior;
control data generating circuitry to generate a command value for controlling the control device, and transmit the command value to the device controller;
first data collection circuitry to receive data from the control device; and
first data management circuitry to manage the command value from the control data generating circuitry, the data from the first data collection circuitry, and data from non-real-time data processing circuitry that performs a process on a non-real-time operating system, and
the non-real-time data processing unit including:
second data collection circuitry to receive input information from an input device connected to an exterior; and
second data management circuitry to manage, the input information from the second data collection circuitry, and data from the real-time data processing circuitry,
the method comprising:
transferring at least one of the command value or the data from the first data collection circuitry to the real-time data processing circuitry by the non-real-time data processing circuitry; and
transferring the input information to the non-real-time data processing circuitry by the real-time data processing circuitry.

7. An information transfer apparatus, comprising
non-real-time data processing circuitry to perform a process on a non-real-time operating system,
the non-real-time data processing circuitry including:
second data collection circuitry to receive input information from an input device connected to an exterior; and
second data management circuitry to manage the input information from the second data collection circuitry, and data from real-time data processing circuitry that performs a process on a real-time operating system,
the real-time data processing circuitry including:
a device controller to control a control device connected to an exterior;
control data generating circuitry to generate a command value for controlling the control device, and transmit the command value to the device controller;
first data collection circuitry to receive data from the control device; and
first data management circuitry to manage the command value from the control data generating circuitry, the data from the first data collection circuitry, and data from the non-real-time data processing circuitry.

8. The information transfer apparatus according to claim 7,
wherein the non-real-time data processing circuitry further includes data processing circuitry that generates processed data based on the input information,
the second data management circuitry stores, through the first data management circuitry, the processed data in a real-time data storage handled by the real-time data processing circuitry, and
the control data generating circuitry obtains the processed data from the real-time data storage through the first data management circuitry.

9. The information transfer apparatus according to claim 7,
wherein the non-real-time data processing circuitry further includes data processing circuitry that generates processed data based on the input information, and
when a real-time data storage handled by the real-time data processing circuitry does not store the processed data, the first data management circuitry requested of the processed data from the control data generating circuitry obtains, through the second data management circuitry, the processed data from a non-real-time data storage handled by the non-real-time data processing circuitry.

10. The information transfer apparatus according to claim 7, further comprising
time providing circuitry to provide time information to be added to selection target data to be stored in a real-time data storage handled by the real-time data processing circuitry,
wherein when the control data generating circuitry requests the selection target data, the first data management circuitry selects and obtains the selection target data based on a selection condition that is a condition on the time information for selecting and obtaining the selection target data to which the time information has been added.

11. The information transfer apparatus according to claim 7,
wherein the first data management circuitry stores, in a non-real-time data storage handled by the non-real-time data processing circuitry through the second data management circuitry, at least one of the command value generated by the control data generating circuitry or the data from the first data collection circuitry.
